(19) United States
(12) Patent Application Publication
(10) Pub. No.: US 2002/0031662 A1
(43) Pub. Date: Mar. 14, 2002

(54) Thermal activated adhesive tape films for the collation of wire staples and nails

(76) Inventor: Robert Mahoney, Hampstead, NH (US)

Correspondence Address: Samuels, Gauthier & Stevens LLP, Suite 3300, 225 Franklin Street, Boston, MA, 02110, US

(21) Appl. No.: 09/911,783

(22) Filed: Jul. 24, 2001

Related U.S. Application Data
(60) Provisional application No. 60/220,284, filed on Jul. 24, 2000.

(51) Int. Cl. B32B 7/12

(52) U.S. Cl. 428/349

(57) ABSTRACT

An adhesive tape system for the collation of galvanized fasteners which comprises a PET/LDPE tape, and an adhesive film applied to the tape. The adhesive film comprises a low density polyethylene in an amount of 2 to 98% by weight based upon the total weight of the adhesive, maleic anhydride acid in an amount of 1 to 20% by weight and butylene in an amount of 1 to 20% by weight. The system is a heat activatable system and can be activated at temperatures of <400° F. The adhesive film of the system maintains a bond to galvanized metal after 72 hours of exposure to 95% of relative humidity at 120° F. when the galvanized metal is adhered to the tape according to ASTM standard 903-93.

### BACKGROUND OF THE INVENTION

In the manufacture of fasteners, such as galvanized staples or nails. The staples or nails are placed in seriatim on the surface of a tape. The surface comprises a heat activatable adhesive. The adhesive is activated and the staples are bonded to the tape forming a tape fastener assembly which is then packaged.

In some circumstances, the bonding of galvanized metal surfaces to the tape has not been entirely satisfactory. It has been found that in storage at high humidity, ninety plus percent, and elevated temperatures, up to 120° F., some of the fasteners separate from the tape. Another problem is when these tapes are used in fastening tools, with some adhesives, fasteners peel readily from the film, not tearing, carrying the film out of the gun. The peeled film remaining in the tool can jam the gun. This is known as the ‘flagging’ effect.

Tapes are available to thermally bond to galvanized metal surfaces and resist the temperature and humidity conditions though the adhesive only activates at higher temperatures, e.g. >400° F.

Modified/medium and high density polyethylene polymers generally have been used to provide bonding to galvanized metal surfaces. Some modified high density polymers have been used more for high cohesive strength and stiffness and resistance to humidity at elevated temperatures. However, these modified polyethylene resins require higher temperatures to soften and activate. Copolymer polyethylene resin systems based on low density polyethylene have been used providing low activation temperatures but with marginal bonds to galvanized surfaces and very poor resistance to moisture and humidity.

Broadly, the present invention is directed to an adhesive system and to polymeric tape using the adhesive system. The system is a heat activatable adhesive which can be heat activated at temperatures of <400° F. and adhere to galvanized fasteners such that the galvanized fasteners will remain adhered to the tape even when stored in conditions of >90% humidity and/or 120° F.

In the preferred embodiment, the adhesive system comprises a three-part, low density, polyethylene polymer. The modified low density polyethylene activates at low temperature <400° F., is resistant to humidity and heat, is acid modified for polarity sites for bonding, and embodies a rubber polymer or elastomeric phase to minimize adhesive surface fracture, thus maintaining adhesive bonding. The system provides very aggressive bonds to galvanized surfaces.

### DESCRIPTION OF THE PREFERRED EMBODIMENT(S)

Low gauge, PET tapes exist having a thermally activated heat seal adhesive film on a polyester film. The polyester PET film thickness is typically 31 to 92 gauge (0.0003-0.001″). With total heat seal tape thickness ranging from 0.001 to 0.004″. There may or may not be a separate tie layer bonded to the PET. This tie layer is typically a low density polyethylene film. These PET film/LDPE tie layer tapes are readily available in the packaging marketplace.

In the present invention, the commercially available PET film/tie layer, well understood to one skilled in the art and commonly available in the packaging marketplace, is used and the adhesive of the invention is directly extrusion coated or extruded as a film and laminated onto the tie layer.

### EXAMPLE 1

### Materials

Low density polyethylene (0.870-0.920) 2 to 98% by weight.

Maleic anhydride acid 1 to 20% by weight; and

Synthetic rubber such as butylene 1 to 20% by weight.

The materials were blended in an extruder and extruded as pellets.

The pellets were extrusion coated directly onto or extruded as a film and laminated onto the PET/LDPE tapes in a thickness of between 0.001 to 0.004.

To determine the suitability of the adhesive for its intended purpose, the following tests were conducted.

### Peel Testing

ASTM 903-93 modified as follows.

1. All tapes were slit to ¼″ to stimulate actual tape dimensions and to provide maximum peel test per panel used.

2. Tape samples were heat seal laminated at 200-600° F. at 25 psi for 5 seconds to galvanize metal test panels using a Sentinel Heat Seal Machine. Subsequent peel tests were performed on an Instron Tensile Testing Machine at 2″/min. Peak adhesion was measured and recorded as lbs. per linear inch (pli). The type of bond failure was noted, either adhesion, cohesion or film tear completely. The adhesive typically bonded above 5 lb. per linear inch at surface temperatures set as low as 230° F. The bond was still intact after 72 hours of exposure to 95% of relative humidity at 120° F. Another advantageous characteristic of the adhesive of the invention is that at all activation surface temperatures above 250° F. the bonds failed initially cohesively with film tear ultimately occurring. This indicated high bond strength dependent on the tensile strength of the adhesive film minimizing the ‘flagging’ effect.

Other acids to provide polarity and chemical bonding to metal include carboxylic derivatives, e.g. acrylic acid, methacrylic acid.

Other polymers/copolymers that may be utilized for the backbone include polypropyl and propylene ethylene copolymers, Other compounds for rubber modification include octene and EPDM.

The foregoing description has been limited to a specific embodiment of the invention. It will be apparent, however, that variations and modifications can be made to the invention, with the attainment of some or all of the advantages of the invention. Therefore, it is the object of the appended claims to cover all such variations and modifications as come within the true spirit and scope of the invention.

Having described my invention what I now claim is:

1. An adhesive tape system for the collation of galvanized fasteners which comprises:
a PET/LDPE tape; and
an adhesive film applied to the tape, the adhesive film comprising low density polyethylene in an amount of 2 to 98% by weight based upon the total weight of the adhesive, an acid in an amount of 1 to 20% by weight and a rubber polymer in an amount of 1 to 20% by weight, the adhesive system being heat activatable at temperatures of <400° F., the adhesive film maintaining a bond to galvanized metal after 72 hours of exposure to 95% of relative humidity at 120° F. when the galvanized metal is adhered to the tape according to ASTM standard 903-93.

2. The adhesive tape system of claim 1 wherein the acid is maleic anhydride.

3. The adhesive tape system of claim 2 wherein the rubber polymer is butylene.

4. The adhesive tape system of claim 1 wherein the acid is selected from the group consisting of carboxylic derivatives, acrylic acid and methacrylic acid.
